(19) United States
(12) Patent Application Publication
(10) Pub. No.: US 2026/0290276 A1
(43) Pub. Date: Sep. 24, 2026

(54) DISPLAY DEVICE

(71) Applicant: Sharp Display Technology Corporation, Kameyama City (JP)

(72) Inventor: Keiichi YAMAMOTO, Kameyama City (JP)

(21) Appl. No.: 19/569,108

(22) Filed: Mar. 17, 2026

(30) Foreign Application Priority Data
Mar. 19, 2025 (JP) 2025-046007

(51) Int. Cl. G09G 3/36

(52) U.S. Cl. CPC G09G 3/3677; G09G 3/3688; G09G 2300/0814; G09G 2300/0857; G09G 2330/021

(57) ABSTRACT

A display device includes a plurality of scanning lines, a plurality of data lines, and a plurality of pixels arranged in a display region, a scanning line drive circuit, a data line drive circuit, and a control device. The display region includes a first region, and the plurality of scanning lines include a plurality of first scanning lines arranged in the first region. The control device controls the scanning line drive circuit and thus causes scanning of all the plurality of scanning lines in each of a plurality of main frame periods that are repeated in a cycle of a total frame period, and controls the scanning line drive circuit and thus causes scanning of all the plurality of first scanning lines in at least one first sub-frame period arranged between the main frame period and the main frame period immediately following.

### CROSS-REFERENCE TO RELATED APPLICATIONS

This application claims the benefit of priority to Japanese Patent Application Number 2025-046007 filed on Mar. 19, 2025. The entire contents of the above-identified application are hereby incorporated by reference.

### BACKGROUND

### TECHNICAL FIELD

The disclosure relates to a display device.

Head mounted displays and VR goggles are required to display images with high definition. This enormously increases an amount of data of an image to be displayed, and thus increases power consumption of a display device and requires high arithmetic capability for image processing for display, which means that the load for data processing on the display device and the image processing increases.

In contrast, a technology called foveated rendering has been proposed that reduces the amount of data of an image by using the visual characteristics of humans. In the foveated rendering, a region of a display gazed by a user who uses a head mounted display or VR goggles is rendered at a high resolution, and the other region is rendered at a low resolution.

The eyeball has a region called a fovea that has high visual sensitivity, and the user adjusts the direction of the eyeballs to capture a region to be gazed at with the fovea. Due to this, even when an image in a region other than the region being gazed at has a low resolution, the user is less likely to notice deterioration in image quality. Thus, the image generated by the foveated rendering can provide the user with a high satisfaction level by the high-quality image while achieving a reduction in amount of data.

For example, JP 2024-528865 T discloses a display device that performs display by merging a full frame image with a foveal image.

### SUMMARY

Even in the image by the foveated rendering, it is preferable that an image region having a high resolution be displayed at a high frame rate. On the other hand, in an image region having a low resolution, the frame rate may be low. Reduction in frame rate can reduce the amount of data of an image, and reduce power consumption of the display device. An object of the disclosure is to provide a display device capable of displaying a part of a display region at a different frame rate.

According to an embodiment of the disclosure, there is provided a display device including a plurality of scanning lines individually extending in a first direction, the plurality of scanning lines being arrayed in parallel to each other in a display region, a plurality of data lines individually extending in a second direction intersecting the first direction, the plurality of data lines being arrayed in parallel to each other in the display region, a plurality of pixels each of which is connected to one of the plurality of scanning lines and one of the plurality of data lines, the plurality of pixels being arranged in the display region, a scanning line drive circuit configured to drive the plurality of scanning lines, a data line drive circuit configured to drive the plurality of data lines, and a control device configured to control the scanning line drive circuit and the data line drive circuit, wherein the display region includes a first region, the plurality of scanning lines include a plurality of first scanning lines arranged in the first region, and the control device controls the scanning line drive circuit and thus causes scanning of all the plurality of scanning lines in each of a plurality of main frame periods that are repeated in a cycle of a total frame period, and the control device controls the scanning line drive circuit and thus causes scanning of all the plurality of first scanning lines in at least one first sub-frame period arranged between the main frame period and the main frame period immediately following.

According to an embodiment of the disclosure, a display device capable of displaying a part of a display region at a different frame rate is provided.

### BRIEF DESCRIPTION OF DRAWINGS

The disclosure will be described with reference to the accompanying drawings, wherein like numbers reference like elements.

FIG. 1 is a block diagram illustrating a schematic configuration of a display device according to an embodiment.

FIG. 2 is a circuit diagram illustrating a pixel configuration example of the display device.

FIG. 3 is a schematic view illustrating a video signal V generated by a host computer.

FIG. 4 is a plan view illustrating arrangement of scanning lines in a display region according to a first embodiment.

FIG. 5A is a schematic view illustrating timings to scan the scanning lines according to the first embodiment.

FIG. 5B is a schematic view illustrating timings to scan scanning lines in a typical display device.

FIG. 6 is a circuit diagram illustrating an example of a scanning line drive circuit according to the first embodiment.

FIG. 7 is a timing chart of signals and scanning signals input to the scanning line drive circuit according to the first embodiment.

FIG. 8 is a plan view illustrating arrangement of scanning lines in a display region according to a second embodiment.

FIG. 9A is a schematic view illustrating timings to scan the scanning lines according to the second embodiment.

FIG. 9B is a schematic view illustrating scanning timings when the device of the second embodiment is driven at the scanning timings of the first embodiment.

FIG. 10 is a circuit diagram illustrating an example of a scanning line drive circuit according to the second embodiment.

FIG. 11 is a timing chart of signals and scanning signals input to the scanning line drive circuit according to the second embodiment.

FIG. 12 is a plan view illustrating arrangement of scanning lines in a display region according to a third embodiment.

FIG. 13A is a schematic view illustrating timings to scan the scanning lines according to the third embodiment.

FIG. 13B is a schematic view illustrating another type of timings to scan the scanning lines according to the third embodiment.

FIG. 14 is a circuit diagram illustrating an example of a scanning line drive circuit according to the third embodiment.

FIG. 15 is a timing chart of signals and scanning signals input to the scanning line drive circuit according to the third embodiment.

### DESCRIPTION OF EMBODIMENTS

Embodiments of the disclosure will be described below with reference to the drawings. The disclosure is not limited to the following embodiments, and appropriate design changes can be made within a scope that satisfies the configuration of the disclosure. Further, in the description below, the same reference signs may be used in common among the different drawings for the same portions or portions having the same or similar functions, and descriptions of repetitions thereof may be omitted. Further, each of the configurations described in the embodiments may be combined or modified as appropriate within a range that does not depart from the gist of the disclosure. For ease of explanation, in the drawings referenced below, configurations may be simplified or schematically illustrated, or a portion of the components may be omitted. Further, dimensional ratios between components illustrated in the drawings are not necessarily indicative of actual dimensional ratios.

### First Embodiment

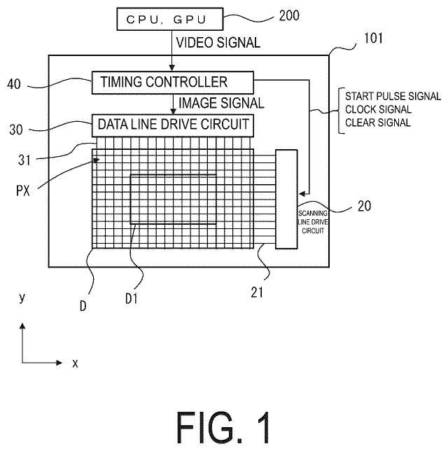

FIG. 1 is a block diagram illustrating a schematic configuration of a display device 101 according to the present embodiment. The display device 101 may be a liquid crystal display device or an organic EL display device. The display device 101 includes a plurality of scanning lines 21, a plurality of data lines 31, a plurality of pixels PX, which are disposed in a display region D, a scanning line drive circuit 20, a data line drive circuit 30, and a timing controller 40.

In the display region D, the plurality of scanning lines 21 individually extend in a row direction (x-axis, first direction) and are arrayed in parallel to each other. In addition, the plurality of data lines 31 individually extend in a column direction (y-axis, second direction) intersecting the row direction and are arrayed in parallel to each other.

The plurality of pixels PX are two-dimensionally arrayed in the row direction and the column direction in the display region D, and each pixel PX is connected to one of the plurality of scanning lines 21 and one of the plurality of data lines 31.

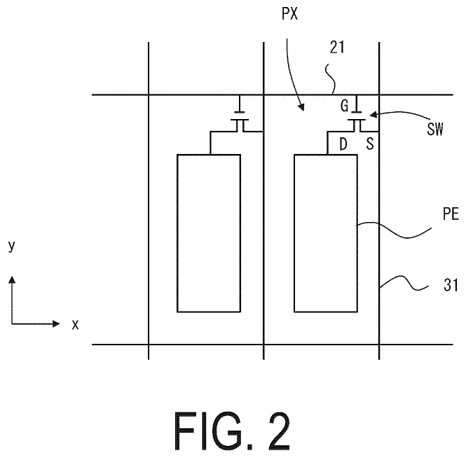

FIG. 2 is a circuit diagram illustrating a configuration example of a pixel PX in a case in which the display device 101 is a liquid crystal display device. Each of the pixels PX includes a switching element SW and a pixel electrode PE. The switching element SW is, for example, a thin film transistor, and a gate G of the thin film transistor is connected to the scanning line 21, and a source S is connected to the data line 31. A drain D of the thin film transistor is connected to the pixel electrode PE.

As will be described below, when a scanning signal is sequentially applied to the plurality of scanning lines 21 to scan the scanning lines, the switching element SW of the pixel PX connected to the scanning line 21 to which the scanning signal is applied is turned on. At this timing, a data signal applied to the data line 31 is applied to the pixel electrode PE via the switching element SW. As a result, the pixel PX is turned on at a luminance determined by the voltage of the data signal.

The scanning line drive circuit 20 is connected to the plurality of scanning lines 21. Further, the data line drive circuit 30 is connected to the plurality of data lines 31.

The timing controller 40 controls the scanning line drive circuit 20 and the data line drive circuit 30. The timing controller 40 receives a video signal from a host computer 200, which is an external device including a CPU, a GPU, and the like, generates an image signal, and outputs the image signal to the data line drive circuit 30. The timing controller 40 generates a start pulse signal, a clear signal, and a clock signal and outputs the signals to the scanning line drive circuit 20.

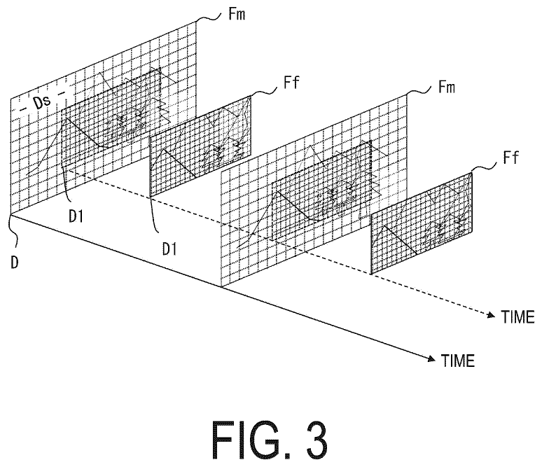

The host computer 200 generates the above-described video signal. FIG. 3 is a schematic view illustrating a video signal V generated by the host computer 200. The video signal includes a main frame Fm that is an image of the entire display region D and a foveal frame Ff that is an image of a first region D1 as a partial region included in the display region D. The main frames Fm and the foveal frames Ff are alternately arranged on a time axis. Since the main frame Fm includes the image of the first region D1, that is, the main frame Fm also includes the foveal frame Ff, the image of the first region D1 is configured at a frame rate twice that of the entire image.

The main frame Fm may be an image formed by foveated rendering. In detail, a resolution of the portion of the first region D1 in the image of the main frame Fm of the entire display region D may be set to be higher than a resolution of a standard region Ds located around the first region D1. For example, the first region D1 in the main frame Fm and the entire foveal frame Ff may be configured by an image generated at a dot-by-dot resolution for individual pixels of the display device 101, and the standard region Ds outside the first region D1 in the main frame Fm may be configured by an image generated by treating four pixels as grouped one pixel.

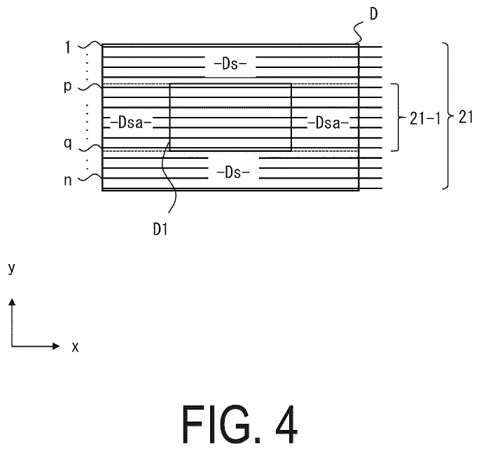

FIG. 4 is a plan view illustrating arrangement of the scanning lines 21 in the display region D. The plurality of scanning lines 21 are arranged in the column direction in the display region D. In the present embodiment, the first region D1 is arranged at a central portion of the display region D at least in the column direction. In the example illustrated in FIG. 4, the first region D1 is also arranged at a central portion in the row direction. For example, a width of the first region D1 is ½ a width of the display region D in the row direction, and a height of the first region D1 is ½ a height of the display region D in the column direction.

The plurality of scanning lines 21 include a plurality of first scanning lines 21-1 arranged in the first region D1. When the plurality of scanning lines 21 arrayed in the row direction are denoted by using 1, 2, . . . , p, . . . , q, . . . , n (p<q<n) in order from the top, the first scanning lines 21-1 are located at p-th to q-th positions.

An image is displayed by scanning the plurality of scanning lines 21, and the image is displayed in units of rows. Thus, when the foveal frame Ff is displayed in the first region D1, the image may be updated at the same timing as that in the first region D1 even in a region Dsa adjacent to the first region D1 in the row direction in the standard region Ds. However, in the region Dsa, the same image as that in the region Dsa in the main frame Fm immediately preceding is repeatedly displayed, thereby causing the amount of data of the video signal to be reduced.

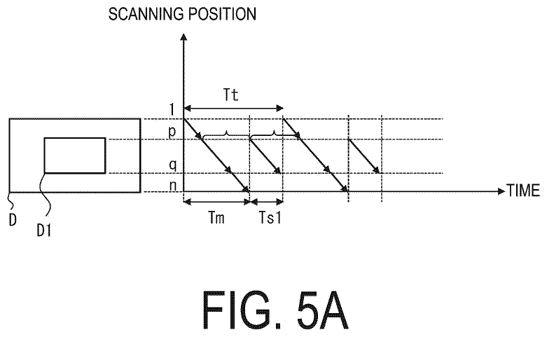

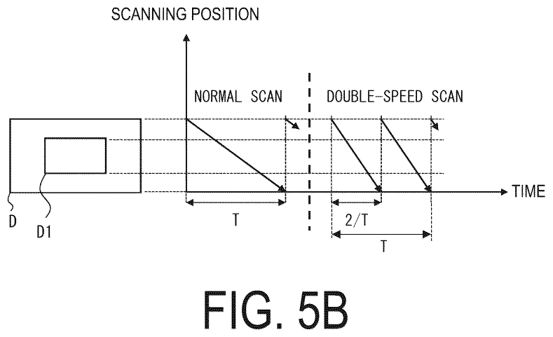

Next, operations of the display device 101 will be described. FIG. 5A is a schematic view illustrating timings to scan the scanning lines according to the present embodiment, and FIG. 5B is a schematic view illustrating timings to scan scanning lines in a typical device. In FIG. 5A and FIG. 5B, the horizontal axis represents time, and the vertical axis represents the scanning positions of the scanning lines 21. The scanning line 21 is driven by the scanning line drive circuit 20 based on the control of the timing controller 40.

As illustrated in FIG. 5B, for example, a scanning method of scanning the entire display region D once in a frame period T is used as a reference. In order to scan the entire display region D twice within the same time, it is necessary to double the frame rate and halve the frame period, which is one scanning time.

In contrast, in the present embodiment, as illustrated in FIG. 5A, first, in a main frame period Tm, the scanning line drive circuit 20 scans all the plurality of scanning lines 21 in the display region D. Thereby, the image of the main frame Fm illustrated in FIG. 3 is displayed.

Subsequently, in a first sub-frame period Ts1, the scanning line drive circuit 20 scans all the plurality of first scanning lines 21-1 in the first region D1. The total time of the main frame period Tm and the first sub-frame period Ts1 is a total frame period Tt, and the main frame period Tm and the first sub-frame period Ts1 are repeated in a cycle of the total frame period Tt.

In the total frame period Tt, the entire display region D is scanned once, and the first region D1 is scanned once separately from the scanning of the entire display region D. Since the scanning of the entire display region D includes the scanning of the first region D1, the first region D1 is scanned twice in the total frame period Tt. Thus, in the first region D1 that is a region to which a user pays attention, an image can be displayed at a frame rate twice as high as that in the surrounding region, causing an improvement in display quality. In addition, the number of scanning lines to be scanned is reduced as compared to a case where the frame rate of the entire display region is increased, so that the power consumption of the display device 101 can be reduced.

Further, the main frame period Tm and the first sub-frame period Ts1 having different lengths are alternately repeated, and the first region D1 is scanned in each of the periods, but the first region D1 is scanned in a constant cycle. This makes it possible to improve the display quality of the image of the foveal frame displayed in the first region D1.

Further, the slope of the straight line indicating the scanning positions with respect to time illustrated in FIG. 5A is smaller than the slope of the straight line indicating the scanning positions with respect to time in a case of performing scanning at a doubled frame rate in FIG. 5B. This means that the frequency of a clock signal for driving the scanning lines can be made lower than that in the case of scanning at the doubled frame rate. That is, according to the present embodiment, the frame rate of the first region D1 can be doubled at a doubled drive frequency or lower, and the power consumption of the display device 101 can also be reduced from the perspective that the drive frequency can be suppressed to be low.

Such driving of the scanning lines can be implemented by using the scanning line drive circuit 20 capable of starting scanning from an intermediate one of the plurality of scanning lines arrayed in the column direction.

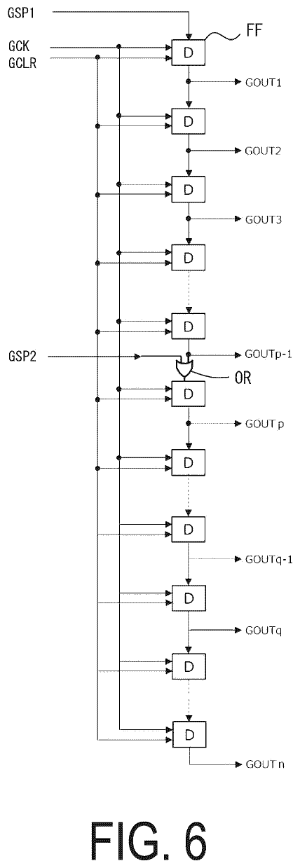

FIG. 6 is a circuit diagram illustrating an example of the scanning line drive circuit 20 capable of performing such an operation. The scanning line drive circuit 20 includes a plurality of D-type flip-flop circuits FF (hereinafter, abbreviated as FF circuits FF) connected in cascade, and an OR circuit OR disposed in at least one of spaces between the plurality of FF circuits FF. Outputs GOUT1 to GOUTn of the plurality of FF circuits FF are individually connected to the plurality of scanning lines 21 including the first scanning lines 21-1. In the present embodiment, the OR circuit OR is disposed between the (p−1)-th FF circuit FF and the p-th FF circuit FF.

A start pulse signal GSP1 for starting scanning in the main frame period is input to a leading FF circuit FF. Further, a start pulse signal GSP2 for starting scanning in the first sub-frame period is input to the OR circuit OR. Further, shift clock signals GCK1 and/or GCK2 and a clear signal GCLR are input to each FF circuit FF. These signals are generated by the timing controller 40 and input to the scanning line drive circuit 20.

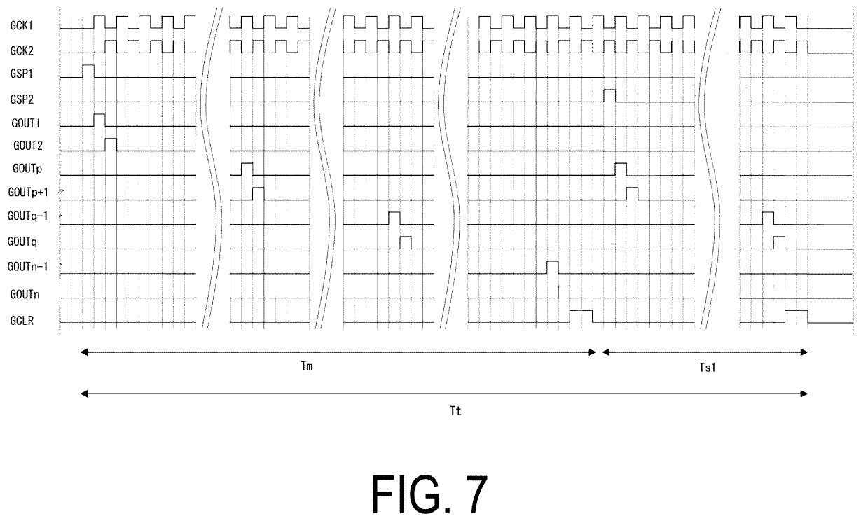

FIG. 7 is a timing chart illustrating the timing of each of these signals. First, when the start pulse signal GSP1 is input to the leading FF circuit FF, a scanning signal is sequentially input to the first to n-th scanning lines 21 including the first scanning lines 21-1, and scanning in the main frame period Tm is performed. Thereby, an image of the main frame Fm is displayed. After the scanning signal is output to the n-th scanning line 21, the clear signal GCLR is input to each FF circuit FF, and then, each FF circuit FF is reset.

Thereafter, the start pulse signal GSP2 is input to the OR circuit OR, and thus, the scanning signal is sequentially input to the plurality of first scanning lines 21-1 that are the p-th to q-th scanning lines 21, and scanning in the first sub-frame period Ts1 is performed. Thereby, an image of the foveal frame Ff is displayed. After the scanning signal is output to the first scanning line 21-1 that is the scanning line 21 at the q-th position, the clear signal GCLR is input to each FF circuit FF, and then, each FF circuit FF is reset. Thereafter, the main frame period Tm and the first sub-frame period Ts1 are repeated.

As described above, according to the display device of the present embodiment, a part of the display region can be displayed at a different frame rate, and for example, in an image by foveated rendering, an image region with a high resolution can be displayed at a high frame rate, and an image region with a low resolution can be displayed at a low frame rate. Thus, the power consumption of the display device can be reduced.

### Second Embodiment

A display device according to the present embodiment is different from the first embodiment in that the first region D1 in which the image of the foveal frame is displayed is arranged at a position shifted from a central portion of the display region in the row direction.

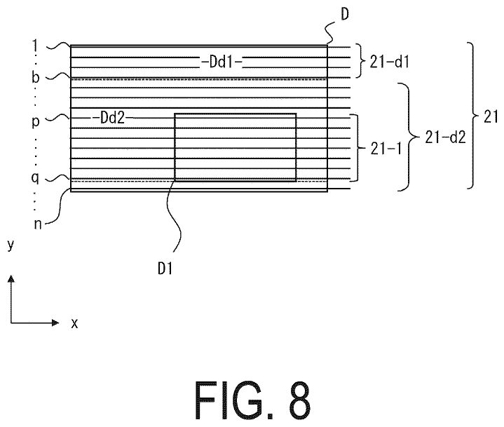

FIG. 8 is a plan view illustrating arrangement of the scanning lines 21 in the display region D according to the present embodiment.

In the display region D, the first region D1 is shifted from the central portion of the display region D at least in the column direction. In the present embodiment, the first region D1 is shifted from the central portions in both the row direction and the column direction. In particular, the first region D1 is shifted downward from the central portion in the column direction and is shifted rightward from the central portion in the row direction. As in the first embodiment, the first scanning line 21-1 is arranged in the first region D1.

The display region D includes a first divided region Dd1 and a second divided region Dd2 that are divided by a boundary extending in the row direction. The first divided region Dd1 and the second divided region Dd2 are arranged in the column direction, and the first divided region Dd1 is located above the second divided region Dd2. Additionally, the entire first region D1 is included in either the first divided region Dd1 or the second divided region Dd2. In the example illustrated in FIG. 8, the first region D1 is included in the second divided region Dd2.

The plurality of scanning lines 21 further include a plurality of first divided scanning lines 21-d1 located in the first divided region Dd1 and a plurality of second divided scanning lines 21-d2 located in the second divided region Dd2. In the present embodiment, since the first region D1 is included in the second divided region Dd2, the first scanning lines 21-1 are also included in the second divided scanning lines 21-d2.

When the plurality of scanning lines 21 arranged in the row direction are denoted by 1, 2, . . . , b, . . . , p, . . . , q, . . . , n (b, p<q<n) in order from the top, the first divided scanning lines 21-d1 are located at the first to (b−1)-th positions, the second divided scanning lines 21-d2 are located at the b-th to n-th positions, and the first scanning lines 21-1 are located at the p-th to q-th positions.

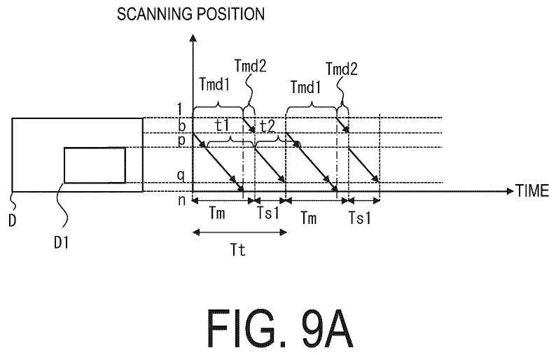

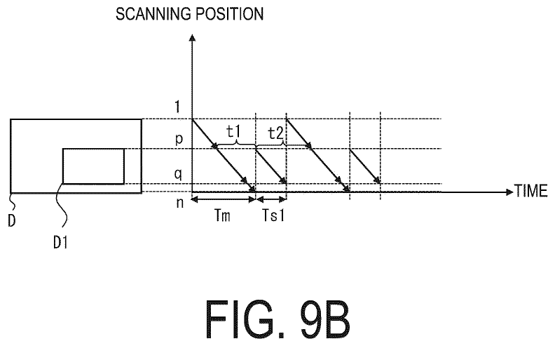

Next, an operation of the display device according to the present embodiment will be described. FIG. 9A is a schematic view illustrating timings to scan the scanning lines according to the present embodiment, and FIG. 9B is a schematic view illustrating scanning timings in a case where the display device of the present embodiment is scanned at the same timings as those of the first embodiment. In FIG. 9A and FIG. 9B, the horizontal axis represents time and the vertical axis represents the scanning positions of the scanning lines 21, as in FIG. 5A and FIG. 5B.

As illustrated in FIG. 9B, for example, the first to n-th scanning lines 21 arranged in the entire display region D are scanned in the main frame period Tm, and the first scanning lines 21-1 located at the p-th to q-th positions are scanned in the first sub-frame period Ts1 immediately following. In this case, as illustrated in FIG. 9B, since the first region D1 is shifted downward from the central portion in the column direction, for example, a period t2 from when the p-th first scanning line 21-1 is scanned in the first sub-frame period Ts1 to when the p-th first scanning line 21-1 is scanned in the main frame period Tm immediately following is longer than a period t1 from when the p-th first scanning line 21-1 is scanned in the main frame period Tm to when the p-th first scanning line 21-1 is scanned in the first sub-frame period Ts1 immediately following, and the period t1 and the period t2 are not equal to each other. Thus, the frame rate at which the first region D1 is scanned is not constant, and it is difficult to smoothly display a moving image.

In contrast, in the present embodiment, as illustrated in FIG. 9A, the position of the scanning line 21 to start scanning is changed from the first position in the main frame period Tm. That is, the scanning is started from the second divided region Dd2 of the first divided region Dd1 and the second divided region Dd2 that are arranged in the column direction. This allows the timing to scan the p-th first scanning line 21-1 included in the second divided region Dd2 in the main frame period Tm to be adjusted.

From the viewpoint of scanning timings, in the main frame period Tm, the second divided main frame period Tmd2 in which the second divided scanning lines 21-d2 are scanned is positioned before the first divided main frame period Tmd1 in which the first divided scanning lines 21-d1 are scanned. Thus, the scanning line drive circuit 20 starts scanning from the second divided scanning line 21-d2 that is a b-th scanning line 21 in the second divided main frame period Tmd2, and scans all the second divided scanning lines 21-d2 including the first scanning lines 21-1. Subsequently, the scanning line drive circuit 20 starts scanning from the first divided scanning line 21-d1 that is a leading scanning line 21 in the first divided main frame period Tmd1, and scans all the first divided scanning lines 21-d1. Due to this, all the scanning lines 21 are scanned once in the main frame period Tm.

Subsequently, in the first sub-frame period Ts1, the scanning line drive circuit 20 scans all the plurality of first scanning lines 21-1. The total time of the main frame period Tm and the first sub-frame period Ts1 is the total frame period Tt, and the main frame period Tm and the first sub-frame period Ts1 are repeated in a cycle of the total frame period Tt.

According to such scanning, as described above, the timing to scan the p-th first scanning line 21-1 in the main frame period Tm can be adjusted. Thus, the length of the period t1 from when the p-th first scanning line 21-1 is scanned in the main frame period Tm to when the p-th first scanning line 21-1 is scanned in the first sub-frame period Ts1 immediately following can be the same as the length of the period t2 from when the p-th first scanning line 21-1 is scanned in the first sub-frame period Ts1 to when the p-th first scanning line 21-1 is scanned in the main frame period Tm immediately following. This enables smooth display of a moving image in the first region D1, and thus, the display device being capable of making the drive frequency different in a part of the display region and having high display quality is achieved.

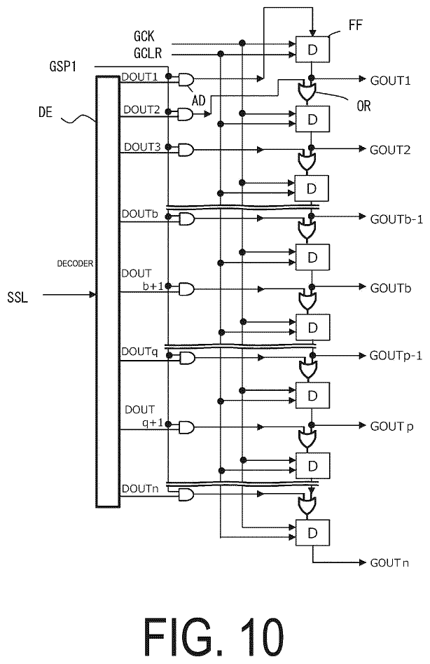

Such driving of the scanning lines can be implemented by using a scanning line drive circuit 20′ capable of starting scanning from a given scanning line among a plurality of scanning lines arranged in the column direction. FIG. 10 is a circuit diagram illustrating an example of the scanning line drive circuit 20′ of the display device according to the present embodiment.

The scanning line drive circuit 20′ includes a plurality of D-type flip-flop circuits FF (hereinafter, abbreviated as FF circuits FF) connected in cascade, and a plurality of OR circuits OR individually arranged in spaces between the plurality of FF circuits FF. Each of the outputs GOUT1 to GOUTn of the plurality of FF circuits FF is connected to respective one of the plurality of scanning lines 21 including the first scanning lines 21-1, the first divided scanning lines 21-d1, and the second divided scanning lines 21-d2.

The scanning line drive circuit 20′ further includes a decoder DE and a plurality of AND circuits AD. The decoder DE is a 1-to-n decoder including n output terminals, and receives a scanning start line signal SSL and outputs a start line signal to a selected one of the n output terminals. Each of the plurality of AND circuits AD is arranged between an output terminal of the decoder DE and an input terminal of an OR circuit OR. A gate start pulse signal GSP1 is input to the other input terminal of each of the plurality of AND circuits AD.

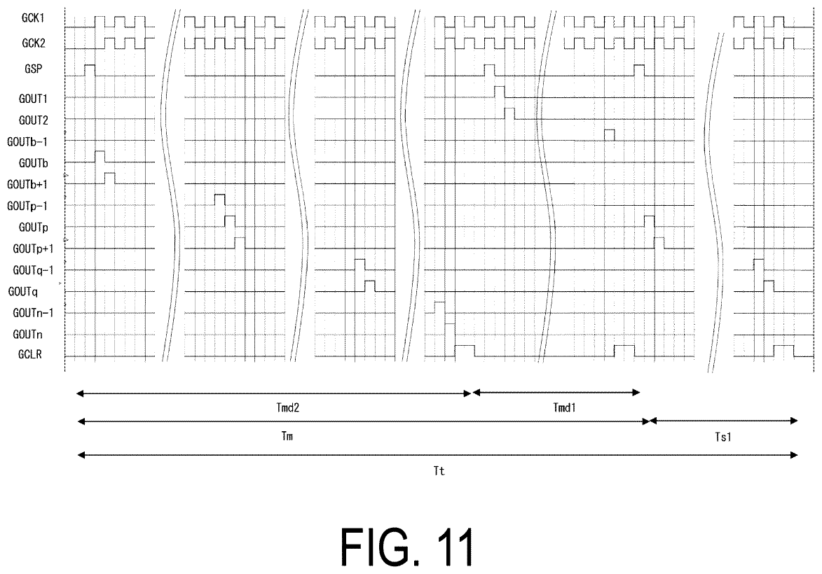

FIG. 11 is a timing chart illustrating the timing of each of these signals. When the timing controller 40 outputs a scanning start line signal designating a b-th position, a start line signal is output from a b-th output terminal DOUTb of the decoder DE. When the start pulse signal GSP1 is output at this timing, a b-th AND circuit AD is turned on, and the start pulse signal is input to the OR circuit OR connected to an input terminal of a b-th FF circuit FF. This starts scanning in order from the second divided scanning line 21-d2 that is the b-th scanning line 21 and thus, starts the second divided main frame period Tmd2. The n-th second divided scanning line 21-d2 is scanned, the clear signal GCLR is input to each FF circuit FF, thereby resetting each FF circuit FF. This ends the second divided main frame period Tmd2.

Subsequently, the timing controller 40 outputs a scanning start line signal for designating a first position, and the decoder DE outputs a start line signal from a first output terminal DOUT1. At this timing, the start pulse signal GSP1 is output, a leading AND circuit AD is turned on, and a start pulse signal is input to an input terminal of the leading FF circuit FF. This starts scanning in order from the first divided scanning line 21-d1 that is the leading scanning line 21. The first divided main frame period Tmd1 ends after the (b−1)-th first divided scanning line 21-d1 is scanned. The clear signal GCLR is input to each FF circuit FF, thereby resetting each FF circuit FF.

Thereafter, when a scanning start line signal designating the p-th position is output from the timing controller 40, a start line signal is output from a p-th output terminal DOUTp of the decoder DE. When the start pulse signal GSP1 is output at this timing, the p-th AND circuit AD is turned on, and the start pulse signal is input to the OR circuit OR connected to an input terminal of the p-th FF circuit FF. This starts scanning in order from the first scanning line 21-1 that is the p-th scanning line 21. The first sub-frame period Ts1 ends after the q-th first scanning line 21-1 is scanned. The clear signal GCLR is input to each FF circuit FF, thereby resetting each FF circuit FF.

As described above, according to the display device of the present embodiment, even when the position of the image of the foveal frame is not at a central portion of the display region, the foveal image can be displayed at a higher frame rate and with higher display quality than those in the other region.

Further, according to the display device of the present embodiment, the display region can be scanned from a given scanning line designated by the scanning start line signal. Thus, the display device according to the present embodiment can also handle an image in which the position of the first region for displaying the foveal frame dynamically changes.

For example, a detector such as a camera that detects the movement of the iris, the pupil, or the like of a user is provided in a head mounted display or VR goggles, and the host computer 200 detects, in real time, a position in the display region that the user is paying attention to. Further, the host computer 200 determines the first region based on the detected position, and generates a video signal of a display image with increased resolution and frame rate by foveated rendering treating the first region as a foveal image. In addition, a scanning start line signal for designating the b-th and p-th positions described above is generated according to the position of the first region. The host computer 200 outputs the generated video signal and scanning start line signal to the timing controller 40 in real time, so that the first region can be moved in real time.

### Third Embodiment

A display device according to the present embodiment is different from that of the first embodiment in that a display region includes three regions having different frame rates.

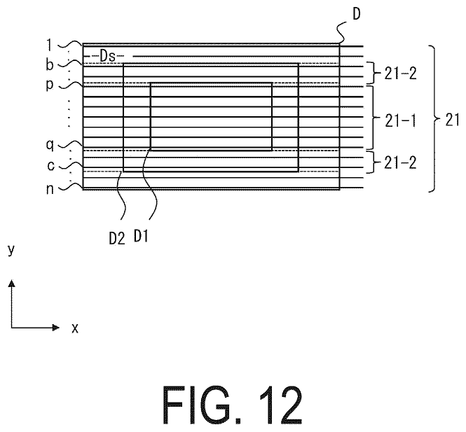

FIG. 12 is a plan view illustrating arrangement of the scanning lines 21 in the display region D according to the present embodiment.

The display region D includes a second region D2 surrounding a first region D1 and a standard region Ds surrounding the second region D2. The plurality of scanning lines 21 include a plurality of first scanning lines 21-1 located in the first region D1 and a plurality of second scanning lines 21-2 not located in the first region D1 but located only in the second region D2. The remaining scanning lines 21 are not located in the second region D2, and are arranged only in the standard region Ds.

When the plurality of scanning lines 21 arrayed in the row direction are denoted by 1, 2, . . . , b, . . . , p, . . . , q, . . . , c, . . . , n (b<p<q<c<n) in order from the top, the first scanning lines 21-1 are located at the p-th to q-th positions, and the second scanning lines 21-2 are located at the b-th to (p−1)-th and (q+1)-th to c-th positions.

As in the first embodiment, an image displayed in the display region D may be an image by foveated rendering. In particular, the image of the portion located in the second region D2 may be higher in resolution than the image of the portion located in the standard region Ds, and the image of the portion located in the first region D1 may be higher in resolution than the image of the portion located in the second region D2. For example, the image of the portion located in the first region D1 may be formed by an image generated at a dot-by-dot resolution for individual pixels of the display device 101, the image of the portion located in the second region D2 may be formed as an image in which four pixels are treated as grouped one pixel, and the image of the portion located in the standard region Ds may be formed as an image in which nine pixels are treated as grouped one pixel.

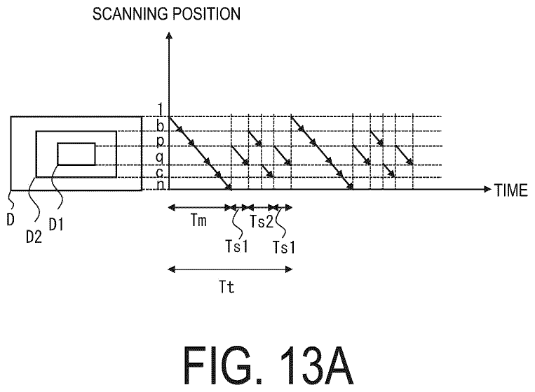

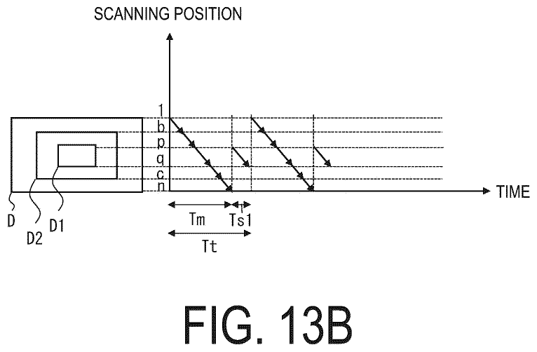

Next, an operation of the display device 101 according to the present embodiment will be described. FIG. 13A is a schematic view illustrating timings to scan the scanning lines according to the present embodiment. In FIG. 13A, the horizontal axis represents time, and the vertical axis represents the scanning positions of the scanning lines 21. The scanning line 21 is driven by the scanning line drive circuit 20 based on the control of the timing controller 40.

As illustrated in FIG. 13A, first, in the main frame period Tm, the scanning line drive circuit 20 sequentially scans the first to n-th scanning lines 21 including the first scanning lines 21-1 and the second scanning lines 21-2. Thus, all the plurality of scanning lines 21 are scanned once in the main frame period Tm.

After that, the scanning line drive circuit 20 scans all the p-th to q-th first scanning lines 21-1 in the first sub-frame period Ts1.

Next, the scanning line drive circuit 20 scans all the b-th to (p−1)-th and (q+1)-th to c-th second scanning lines 21-2 in the second sub-frame period Ts2. As illustrated in FIG. 13A, the scanning in the second sub-frame period Ts2 does not include the scanning of the first scanning lines 21-1.

Next, the scanning line drive circuit 20 scans all the p-th to q-th first scanning lines 21-1 in the first sub-frame period Ts1. This ends the total frame period Tt.

The total frame period Tt includes one main frame period Tm and one second sub-frame period Ts2, and includes two first sub-frame periods Ts1. That is, the number of first sub-frame periods Ts1 arranged between the current main frame period Tm and the main frame period Tm immediately following is larger than the number of second sub-frame periods Ts2. Additionally, the main frame period Tm includes scanning of the first scanning lines 21-1 and the second scanning lines 21-2. Thus, in the total frame period Tt, the first region D1 is scanned three times, and the second region D2 is scanned twice.

According to this, in the first region D1, an image is displayed at a frame rate three times as high as that in the standard region Ds, and in the second region D2, an image is displayed at a frame rate twice as high as that in the standard region Ds.

Therefore, it is possible to present an image having a higher frame rate to a user as the position is closer to the central portion of the display region so as to correspond to visual characteristics. In addition, the number of scanning lines to be scanned is reduced as compared to a case where the frame rate of the entire display region is increased, so that the power consumption of the display device 101 can be reduced.

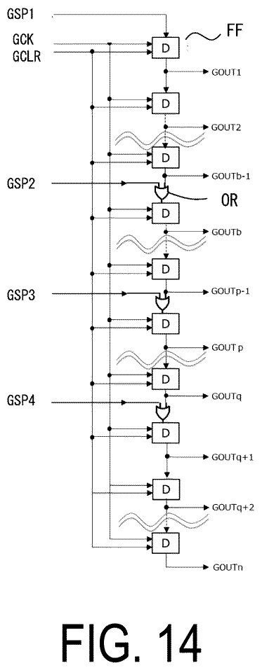

FIG. 14 is a circuit diagram illustrating an example of a scanning line drive circuit 20″ according to the present embodiment. The scanning line drive circuit 20″ is different from the scanning line drive circuit 20 of the first embodiment in that three OR circuits OR are arranged in spaces between the plurality of FF circuits FF connected in cascade in order to start scanning from the b-th, p-th, and (q+1)-th scanning lines positioned as intermediate scanning lines among the first to n-th scanning lines 21.

Specifically, as illustrated in FIG. 14, the OR circuits OR are arranged between the (b−1)-th FF circuit FF and the b-th FF circuit FF, between the (p−1)-th FF circuit FF and the p-th FF circuit FF, and between the q-th FF circuit FF and the (q+1)-th FF circuit FF.

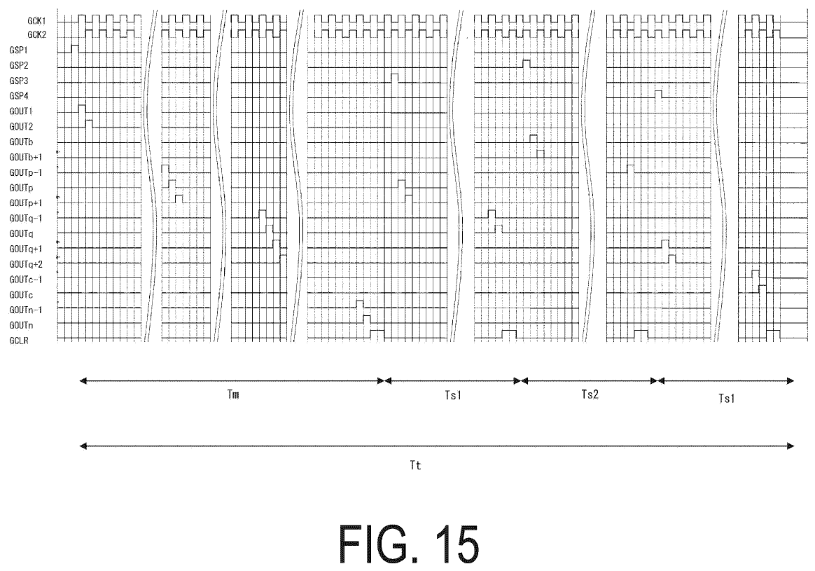

FIG. 15 is a timing chart illustrating signal timings to scan the scanning line drive circuit 20″.

As described in the first embodiment, a start pulse signal GSP3 is input to the OR circuit OR located between the (p−1)-th FF circuit FF and the p-th FF circuit FF at the timing of scanning the first region D1. This starts the first sub-frame period Ts1. Similarly, at the timing of scanning the second region D2, a start pulse signal GSP2 is input to the OR circuit OR located between the (b−1)-th FF circuit FF and the b-th FF circuit FF, and a start pulse signal GSP4 is input to the OR circuit OR located between the q-th FF circuit FF and the (q+1)-th FF circuit FF. Further, the first region D1 is scanned.

Note that the display device of the present embodiment may be driven as in the display device of the first embodiment. As illustrated in FIG. 13B, the same scanning as that of the first embodiment can be performed by not performing the scanning of the second region D2 and the second scanning of only the first region D1 after the first region D1 is scanned.

### Other Embodiments

The display device of the disclosure is not limited to those of the embodiments described above, and various modifications may be performed. Moreover, the configuration of the scanning line drive circuit is merely an example, and the scanning line drive circuit may be configured by another circuit.

The display device of the disclosure can be also described as follows.

A display device according to a first configuration including:
a plurality of scanning lines individually extending in a first direction, the plurality of scanning lines being arrayed in parallel to each other in a display region;
a plurality of data lines individually extending in a second direction intersecting the first direction, the plurality of data lines being arrayed in parallel to each other in the display region;
a plurality of pixels each of which is connected to one of the plurality of scanning lines and one of the plurality of data lines, the plurality of pixels being arranged in the display region;
a scanning line drive circuit configured to drive the plurality of scanning lines;
a data line drive circuit configured to drive the plurality of data lines; and
a control device configured to control the scanning line drive circuit and the data line drive circuit, wherein the display region includes a first region,
the plurality of scanning lines include a plurality of first scanning lines arranged in the first region, and
the control device controls the scanning line drive circuit and thus causes scanning of all the plurality of scanning lines in each of a plurality of main frame periods that are repeated in a cycle of a total frame period, and
controls the scanning line drive circuit and thus causes scanning of all the plurality of first scanning lines in at least one first sub-frame period arranged between the main frame period and the main frame period immediately following.

According to the first configuration, a moving image can be displayed by increasing the refresh rate of a partial region in the display region. Since the refresh rate is high only in the partial region, an excessive increase in amount of data of the entire moving image can be suppressed. In addition, power consumption can be reduced compared with a case where the entire screen is driven at a high refresh rate.

In a display device according to a second configuration, in the first configuration, the scanning of the plurality of first scanning lines in the main frame period and the scanning of the plurality of first scanning lines in the first sub-frame period may be performed at timings having a constant interval in the total frame period being continuous. Since the scanning of the first scanning lines performed a plurality of times are performed at the timings having the constant interval, deterioration in display quality is suppressed.

In a display device according to a third configuration, in the first configuration, the display region may include a second region surrounding the first region, the plurality of scanning lines may include a plurality of second scanning lines not located in the first region but located only in the second region, the control device may control the scanning line drive circuit and thus cause scanning of all the plurality of second scanning lines in at least one second sub-frame period located between the main frame period and the main frame period immediately following, and the number of the first sub-frame periods may be larger than the number of the second sub-frame periods, between the main frame period and the main frame period immediately following.

In a display device according to a fourth configuration, in the third configuration, the scanning of the plurality of second scanning lines in the main frame period and the scanning of the plurality of second scanning lines in the second sub-frame period may be performed at timings having a constant interval in the total frame period being continuous. Since the scanning of the second scanning lines are performed a plurality of times at the timings having the constant interval, deterioration in display quality is suppressed.

In a display device according to a fifth configuration, in the first configuration, the first region may be arranged at a central portion of the display region in the second direction. Since the first region is arranged at the central portion of the display region in the column direction, the timings of the scanning of the first scanning lines may be adjusted so as to have a constant interval.

In a display device according to a sixth configuration, in the first configuration, the first region may be arranged at a position shifted from a central portion of the display region in the second direction, the display region may include a first divided region and a second divided region that are divided in a column direction, the first divided region being located above the second divided region, the first region may be included in the first divided region or the second divided region, the plurality of scanning lines may include a plurality of first divided scanning lines located in the first divided region and a plurality of second divided scanning lines located in the second divided region, the main frame period may include a first divided main frame period and a second divided main frame period located before the first divided frame period, and the control device may control the scanning line drive circuit and thus cause scanning of all the plurality of first divided scanning lines in the first divided main frame period and scanning of all the plurality of second divided scanning lines in the second divided main frame period.

According to the sixth configuration, in the main frame period, the scanning is performed from an intermediate one of the scanning lines, and thus the scanning timing of the first scanning lines can be shifted within the main frame period. Thus, when the first region is not arranged at the central portion of the display region in the column direction, the scanning of the first scanning lines can be performed a plurality of times at the timings having a constant interval, and deterioration in display quality is suppressed.

In a display device according to a seventh configuration, in the first configuration, the scanning line drive circuit may include a plurality of flip-flop circuits connected in cascade and an OR circuit disposed in at least one of spaces between the plurality of flip-flop circuits, each of the plurality of scanning lines may be connected to a corresponding flip-flop circuit of the plurality of flip-flop circuits, the scanning in the main frame period may be started by inputting a start pulse to a leading flip-flop circuit among the plurality of flip-flop circuits, and the scanning in the first sub-frame period may be started by inputting another start pulse to the OR circuit.

In a display device according to an eighth configuration, in the sixth configuration, the scanning line drive circuit may include a plurality of flip-flop circuits connected in cascade and a plurality of OR circuits each of which is disposed between corresponding two flip-flop circuits of the plurality of flip-flop circuits, each of the plurality of scanning lines may be connected to a corresponding flip-flop circuit of the plurality of flip-flop circuits, and the scanning in the first divided main frame period, the scanning in the second divided main frame period, and the scanning in the first sub-frame period may be started by inputting a start pulse to one of the plurality of OR circuits.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a plurality of scanning lines individually extending in a first direction, the plurality of scanning lines being arrayed in parallel to each other in a display region;
a plurality of data lines individually extending in a second direction intersecting the first direction, the plurality of data lines being arrayed in parallel to each other in the display region;
a plurality of pixels each of which is connected to one of the plurality of scanning lines and one of the plurality of data lines, the plurality of pixels being arranged in the display region;
a scanning line drive circuit configured to drive the plurality of scanning lines;
a data line drive circuit configured to drive the plurality of data lines; and
a control device configured to control the scanning line drive circuit and the data line drive circuit, wherein the display region includes a first region,
the plurality of scanning lines include a plurality of first scanning lines arranged in the first region, and
the control device
controls the scanning line drive circuit and thus causes scanning of all the plurality of scanning lines in each of a plurality of main frame periods that are repeated in a cycle of a total frame period, and
controls the scanning line drive circuit and thus causes all the plurality of first scanning lines in at least one first sub-frame period arranged between the main frame period and the main frame period immediately following.

2. The display device according to claim 1,
wherein the scanning of the plurality of first scanning lines in the main frame period and the scanning of the plurality of first scanning lines in the first sub-frame period are performed at timings having a constant interval in the total frame period being continuous.

3. The display device according to claim 2,
wherein the display region includes a second region surrounding the first region,
the plurality of scanning lines include a plurality of second scanning lines not located in the first region but located only in the second region,
the control device controls the scanning line drive circuit and thus causes scanning of all the plurality of second scanning lines in at least one second sub-frame period located between the main frame period and the main frame period immediately following, and
the number of the first sub-frame periods is larger than the number of the second sub-frame periods, between the main frame period and the main frame period immediately following.

4. The display device according to claim 3,
wherein the scanning of the plurality of second scanning lines in the main frame period and the scanning of the plurality of second scanning lines in the second sub-frame period are performed at timings having a constant interval in the total frame period being continuous.

5. The display device according to claim 1,
wherein the first region is arranged at a central portion of the display region in the second direction.

6. The display device according to claim 1,
wherein the first region is arranged at a position shifted from a central portion of the display region in the second direction,
the display region includes a first divided region and a second divided region that are divided in a column direction, the first divided region being located above the second divided region,
the first region is included in the first divided region or the second divided region,
the plurality of scanning lines include a plurality of first divided scanning lines located in the first divided region and a plurality of second divided scanning lines located in the second divided region,
the main frame period includes a first divided main frame period and a second divided main frame period located before the first divided frame period, and
the control device controls the scanning line drive circuit and thus cause scanning of all the plurality of first divided scanning lines in the first divided main frame period and scanning of all the plurality of second divided scanning lines in the second divided main frame period.

7. The display device according to claim 1,
wherein the scanning line drive circuit includes
a plurality of flip-flop circuits connected in cascade, and
an OR circuit disposed in at least one of spaces between the plurality of flip-flop circuits,
each of the plurality of scanning lines is connected to a corresponding flip-flop circuit of the plurality of flip-flop circuits,
the scanning in the main frame period is started by inputting a start pulse to a leading flip-flop circuit among the plurality of flip-flop circuits, and
the scanning in the first sub-frame period is started by inputting another start pulse to the OR circuit.

8. The display device according to claim 6,
wherein the scanning line drive circuit includes
a plurality of flip-flop circuits connected in cascade, and
a plurality of OR circuits each of which is disposed between corresponding two flip-flop circuits of the plurality of flip-flop circuits,
each of the plurality of scanning lines is connected to a corresponding flip-flop circuit of the plurality of flip-flop circuits, and
the scanning in the first divided main frame period, the scanning in the second divided main frame period, and the scanning in the first sub-frame period are started by inputting a start pulse to one of the plurality of OR circuits.
